(19) United States
(12) Patent Application Publication
(10) Pub. No.: US 2012/0175204 A1
(43) Pub. Date: Jul. 12, 2012

(54) DAMPER

(75) Inventors: Erik Mario Arnold, Gorxheimertal (DE); Jasmin Koc, Wurzburg (DE)

(73) Assignee: ILLINOIS TOOL WORKS INC., Glenview, IL (US)

(21) Appl. No.: 13/394,728

(22) PCT Filed: Sep. 2, 2010
(86) PCT No.: PCT/US2010/047629

§ 371 Date: Mar. 7, 2012

(30) Foreign Application Priority Data
Sep. 8, 2009 (DE) 10 2009 042 053.3

(51) Int. Cl. F16F 7/00; F16D 57/02; B60Q 1/26; F16F 7/02

(52) U.S. Cl. 188/271; 188/381; 362/488

(57) ABSTRACT

The invention relates to a damper for damping a rotational or linear movement of a component, preferably a component moveably mounted in the passenger compartment of a motor vehicle, having a damper housing, characterized in that at least one illumination source and/or at least one sensor, as well as an electrical connecting device for connecting the illumination source or the sensor to an electrical supply, are integrated into the damper housing.

The invention relates to a damper for damping a rotational or linear movement of a component, preferably a component moveably mounted in the passenger compartment of a motor vehicle, having a damper housing. Such dampers serve for damping the movement of moving components in the passenger compartment of an automobile, for example glove compartment lids or the like. There is a need to illuminate the interior spaces closed or exposed by the component to be damped. WO 2007/080448 A1 describes a damper having an integrated switch. The switch integrated into the damper can be electrically connected to a light source arranged remotely from the damper, for example in a lining of a glove compartment. For this purpose wiring is led from the damper comprising the switch through the lining to the light source. The switch is operated by a movement of the component, for example the glove compartment lid, and thereby activates the light source, for example on opening the glove compartment lid. With the known device, however, the assembly outlay is relatively high. In addition there is the risk that in operation the electrical wiring will sustain damage (loose contact) and the working of the light source will thereby be impaired (interrupted).

Proceeding from the state of the art as explained, the object of the invention is to provide a damper of the type specified in the introductory part, which is capable of affording a robust supply to an electrical or electronic component, such as a light source, with a simplicity that makes it cost-effective to manufacture and assemble.

According to the invention this object is achieved by the subject matter of claim 1. Advantageous developments are set forth in the dependent claims, in the description and in the figures.

For a damper of the aforesaid type the invention achieves the object in that at least one illumination source and/or at least one sensor as well as an electrical connecting device for connecting the illumination source or the sensor to an electrical supply are integrated into the damper housing. According to the invention, therefore, a component, for example an electronic component, in particular an electrically operated sensor and/or an electrically operated light source, together with an electrical connecting device for the electrical supply to the component are integrated into the damper housing. This means that in contrast to the state of the art there is no need for any illumination or sensor separate from the damper. Instead these are integrated into the damper itself. This allows an easy and thereby cost-effective assembly of the illumination and sensor together with the damper in just one assembly operation. A separate mounting for the light source or sensor on or in the vicinity of the component to be damped is not necessary. This therefore also obviates the need for any separate wiring for the electrical supply to the respective component. Instead the electrical connecting device is likewise integrated into the damper housing. The number of electrical connections is thereby reduced and the electrical supply is more robust. The invention affords an integrated system, which in compact form provides illumination and/or sensors according to the intended purpose.

The illumination source may be a light emitting diode, a light guide or a luminous foil, for example. Light emitting diodes are particularly energy-saving and at the same time have a long service life. In addition they are now available in a variety of different colors, so that the illumination can be individually designed. For example, different automobile manufacturers use different colors for their interior lighting. In the state of the art, on the other hand, bulbs, which normally generate white light, are generally used for illumination. Furthermore, with light emitting diodes there is a flexible choice of light intensity or brightness according to the respective intended application. In the state of the art light guides are sometimes also used for illumination. Light emitting diodes are easier to fit, however. The sensor may be a movement sensor, a temperature sensor or a light sensor, for example. This may be connected to a vehicle immobilizer alarm system. This makes it possible, particularly in the case of a convertible, to monitor the glove compartment.

In order to provide a particularly simple and robust electrical supply, the damper may comprise a plug device in electrical contact with the electrical connecting device, for connection to an external electrical supply. The electrical supply to the illumination source or the sensor can then be achieved simply by a plug-and-socket connection. The damper may furthermore comprise an integrated switch or push button, upon actuation of which the illumination source and/or the sensor are activated or deactivated. This is an especially simple way of linking the movement of the component, for example the opener of a glove compartment or the like, to an activation of the light source or the sensor. However, the damper is also feasible without a switch or push button. Light emitting diodes, in particular, have a very low power consumption and at the same time a very long service life, so that it is feasible to leave light emitting diodes permanently switched on.

In an especially practical embodiment a gear wheel, which is torsionally fixed to a rotor rotatably mounted in the damper housing, is provided in or on the damper housing, wherein the damper comprises a gear rack, preferably moving linearly and meshing with the gear wheel. A movement of the component leads to a movement of the gear rack. This in turn drives the gear wheel, which turns the rotor. The rotation of the rotor is damped. In particular, the rotor exerts a damping force on the gear wheel and the gear rack which force is opposed to the movement of the gear wheel and hence the gear rack, so that the movement of the component is also damped. It is furthermore possible for the switch to comprise a switch housing mounted on the damper housing and two fixed electrical contacts located in the switch housing together with a third moveable electrical contact, also located in the switch housing, wherein the moveable contact is moveable between a position electrically connecting the fixed contacts and a position electrically separating the fixed contacts, and wherein the moveable contact is moveable in response to a relative movement between the gear rack and the switch provided on the damper housing. In the event of a movement of the component to be damped, the damper housing and hence the switch housing located on the former can move relative to the gear rack. This can then be translated into a movement of the moveable contact, for example, by providing a projection on the gear rack or on a gear rack guide, the switch housing, in the event of a relative movement between the gear rack or guide and the switch housing, running over the projection, so that the moveable contact is in turn moved between its two positions. A damper with a damper fluid, for example a silicone fluid, in which the rotor rotates in response to a movement of the gear wheel, may be provided in the damper housing. It is also possible, however, for the rotor to comprise at least one friction element, which as the rotor rotates is in frictional contact with a surface of the damper housing. Alternatively it is also feasible to provide an axial damper in the damper housing. Such axial dampers are known in the art.

It is also feasible to use the switch to provide a two-way connection, operation of which performs two functions. For example, on activation of the light source or the sensor, an electrical consumer, such as a glove compartment cooling system, for example, might be deactivated, whilst on deactivation of the light source or the sensor the electrical consumer, for example the glove compartment cooling system is re-activated.

In an especially simple embodiment that is inexpensive to produce at least the damper housing may be composed of a plastic material. This also serves to reduce weight. Other components of the damper, such as any gear rack provided and its guide, or the entire damper may be composed of plastic. Furthermore the electrical connecting device may comprise a metallic conduction device integrated into the damper housing, wherein the damper housing is molded on to the conduction device in an injection molding process. Such injection molded enclosure of the conduction device makes it particularly easy to integrate into the damper housing. The metallic conduction device is particularly easy to manufacture in the form of a punched grid. It is also feasible, however, to lay electrical cables in the damper housing, for example. Here the contacting can by provided via a flexible conductor path, such as a cable or a conductive paste. The conduction device can naturally also be fixed by adhesive bonding, clamping, clipping or embossing.

The invention also relates to a damper according to the invention in the mounted state on a component to be damped, wherein the damper is mounted with its damper housing behind a wall, and wherein the wall comprises an opening, against which the illumination source and/or the sensor are situated. The sensor may obviously also be offset rearwards in relation to the interior space defined by the wall. The component may be arranged on a cover (for example a lid or a flap), which either exposes or closes an interior space at least partially delimited by the wall, wherein the damper housing is mounted on the side of the wall remote from the interior space, and wherein the illumination source and/or the sensor faces towards the interior space through the opening in the wall. The housing may grip behind the wall opening, so that the light source or the sensor extend into the interior space of the glove compartment or the like, for example, and illuminate or monitor this. For this purpose the damper housing may comprise at least one projection and the wall may comprise at least one corresponding recess, through which at least one projection of the damper housing can be fed, wherein at least one projection can be rotated into a position engaging behind the wall by rotating the damper housing, so that the damper housing is fixed to the wall. The projections(s) may latch on the wall in the manner of a bayonet catch. Upon a movement of the component, in particular an opening movement exposing the interior space of glove compartment, for example, the switch is operated and the light source or the sensor is activated. If the component is then closed again, the light source or the sensor may be deactivated again. The illumination source may comprise a diffusor, in order to disperse the light generated by the illumination source.

The component may be a lid of a glove compartment, a lid of a center console, a grab handle, a drinks holder, a lid of an ashtray or a sun visor of an automobile, for example. Center consoles, for example, often have a separate illumination, which in the state of the art needs to be wired. At the same time the covers for the center consoles may be axially damped, in order that they cannot drop down undamped. An axial damper, particularly one into which a switch can be integrated, may be used for the damping of such center consoles. This is not absolutely essential, however. In the case of roof grab handles, for example, which are mounted in the passenger compartment on the inside of the vehicle roof, a damper is usually integrated in the pivot axis of the handle. In this application, too, it is possible to provide the damper according to the invention with a switch, operation of which activates the illumination source or the sensor in the body of the damper. It is also possible, for example, to activate an illumination source automatically when the roof grab handle is pulled downward. Feasible components also include components other than automobile components, for example drawer retraction mechanisms in furniture or the like. All in all any kinematic or moving components, the movement of which is to be damped, are feasible, in particular smaller flaps. Also feasible are covers for make-up boxes or mirror and cosmetic sun visors in motor vehicles.

An exemplary embodiment of the invention will be explained in more detail below with reference to schematic figures, of which:

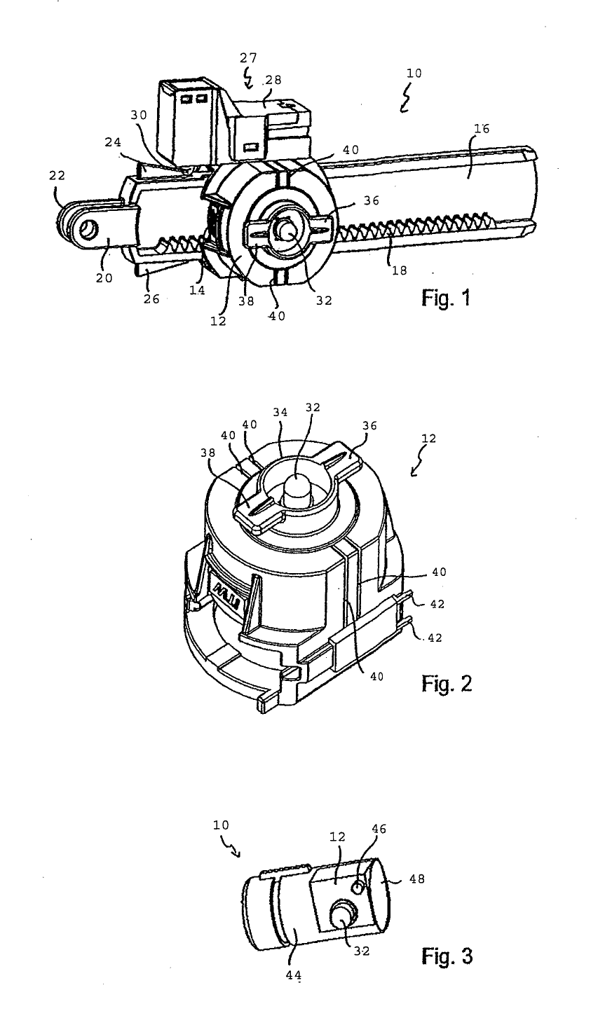

FIG. 1 shows a perspective view of a damper according to the invention,

FIG. 2 shows an enlarged, perspective view of the damper housing of the damper in FIG. 1,

FIG. 3 shows a perspective view of a further exemplary embodiment of a damper according to the invention, and

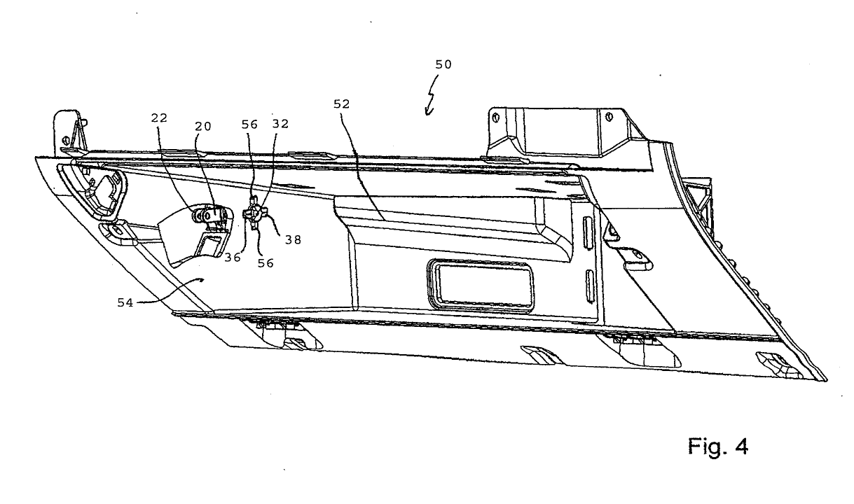

FIG. 4 shows the damper shown in FIG. 1 in a fitted state.

Unless otherwise stated, in the figures the same reference numerals denote the same items. FIG. 1 shows a damper 10 according to the invention for damping a linear movement of a component, in the example shown a glove compartment lid for a glove compartment fitted in an automobile passenger compartment. The damper 10 comprises a damper housing 12, which has a basic cylindrical shape, with a damper, which is integrated into the housing 12. Other housing shapes, for example truncated cone shapes or the like, are naturally also feasible. In the example shown a damper with a damping fluid, in this case a silicone fluid, is contained in the housing 12. Also situated in the damper housing 12 is a rotor, which is arranged in the damping fluid and is rotationally fixed to a gear wheel 14 provided on the outside of the damper. Therefore when the gear wheel turns the rotor is also turned. The damper 10 furthermore comprises a gear rack 18, which is formed on a linear guide 16 and which meshes with the gear wheel 14. Two projections 20, 22 each provided with a bore are arranged at one end of the linear guide 16. The projections 20, 22 serve to attach the damper 10 to the glove compartment lid, by guiding a suitable fastening pin (not shown) through the openings in the projections 20, 22 in a manner known in the art. At the end comprising the projections 20, 22 the linear guide 16 also comprises a projection 24, 26 in the form of a ramp, on each side, one on the upper side and one on the underside. On the upper side in FIG. 1 a switch 27 with a switch housing 28 is arranged on the damper housing 12. Two fixed electrical contacts and a third moveable electrical contact (not shown) are arranged inside the switch housing 28. The moveable contact is connected to a switch stud 30, which in FIG. 1 is moveable vertically in the switch housing 28.

An illumination source 32, in this case a light emitting diode 32, is integrated into the damper housing 12. It can clearly be seen from the enlarged representation in FIG. 2 and is mounted on an end face of the damper housing 12. For reasons of clarity the gear wheel 14 is not shown in FIG. 2. Also provided in the area of the arrangement of the light emitting diode 32 on the damper housing 12 is a bayonet catch 34 having two opposing bayonet projections 36, 38. The bayonet catch 34 serves for fixing the damper 10 to the glove compartment in a manner yet to be explained in more detail below. It can also be seen that an electrical connecting device 40, in this case a metallic punched grid 40, is integrated into the damper housing 12. In the example shown the punched grid 40 is encased by the damper housing 12 of a plastic material in an injection molding method. In the example shown the gear rack 18 with its linear guide 16 together with the projections 20, 22 and 24, 26 have been made from a plastic in an injection molding method. The same applies to the switch housing 28. The metallic punched grid 40 establishes an electrical connection to the light emitting diode 32.

It will be pointed out that in the example shown in FIG. 1 the projections 24, 26 are provided on both side of the linear guide 16, and the punched grid 40 likewise on both sides of the damper housing 12. The reason for this is the facility for bilateral mounting of the damper for right-hand and left-hand linkages of a glove compartment lid, for example. In operation only one of the punched grid connections and one of the projections 24, 26 is then used. With its open ends 42 the metallic punched grid 40 forms a plug device. It serves primarily for bringing the punched grid 40 into electrical contact with the two fixed electrical contacts in the switch housing 28, in particular for plugging it into these. The switch housing 28 likewise has an electrical plug device (not shown), which serves for plugging it into an electrical connection to an external electrical supply.

FIG. 4 shows the damper 10 represented in FIGS. 1 and 2 in the fitted state on a glove compartment 50 of an automobile. Only the interior space 52 of the glove compartment 50, including one wall 54 defining the interior space, is shown here. For the sake of simplicity the glove compartment lid is not shown. It can be seen that the damper 10 with its bayonet catch 34 is fastened to the side wall 54 of the glove compartment 50 through an opening 56 in the wall 54 from the rear side of the wall 54 remote from the interior space of the glove compartment 50. The wall 54 may have a lining. The opening 56 is then accordingly led also through the lining. In the example shown the opening 56 is formed by two recesses 56 corresponding to the projections 36, 38 of the damper housing 12, through which the projections 36, 38 in at least one predefined rotational position can be fed through the wall 54 from the rear side of the wall. It is naturally also possible for the glove compartment to comprise a recess and for the damper to be clipped on or locked outside the glove compartment, and for the light emitting diode or the sensor not to extend into the glove compartment. The damper 10 with its damper housing can then be turned through 90°, so that the projections 36, 38 are also turned through 90°. They then grip behind the wall 54 and thus secure the damper housing 12 and thereby the damper 10 to the wall 54 in the manner of a bayonet catch. The light emitting diode 32 arranged on the end face of the damper housing 12 having the projections 36, 38 then faces the interior space 52 of the glove compartment 50. Also visible are the projections 20, 22 of the linear guide 16 of the gear rack 18, which are connected to the glove compartment lid (not shown).

The damper 10 according to the invention functions as follows: Under a movement of the glove compartment lid, a tensile or compressive force is exerted on the projections 20, 22 and thereby on the gear rack 18 located on the linear guide 16. This leads to a movement of the gear rack 18 in its longitudinal direction. This in turn results in a rotation of the gear wheel 14 meshing with the gear rack 18 and accordingly in a rotation of the rotor arranged in the damper housing 12. The rotation of the rotor leads to a damping force in opposition to the rotation of the gear wheel 14 and thereby of the gear rack 18 and ultimately of the glove compartment lid. At the same time it also results in a relative movement between the gear rack 18 with its linear guide 16 and the damper housing 12 with the switch housing 28 located thereon. In particular, the switch housing 28 with its switch stud 30 traverses on the upper side of the linear guide 16. If the glove compartment lid is closed, for example, the damper housing 12 and thereby the switch housing 28 moves toward the left in the representation shown in FIG. 1. With a sufficient traversing movement, the switch stud 30 strikes the ramp-like projection 24 and in the further course of the movement is pressed into the switch housing 28. The moveable contact located in the switch housing 28 is thereby moved so that it opens the two fixed electrical contacts. In turn the electrical connection between the external electrical supply and the light emitting diode 32 is thereby separated. In this state the light emitting diode 32 therefore no longer illuminates the interior space of the glove compartment 50. If the glove compartment lid is now opened again, an inverse and, for example, similarly damped movement of the damper housing 12 and consequently of the switch housing 28 relative to the linear guide 16 ensues until the switch stud 30 runs downwards back out of the switch housing 28 and therefore adjusts the moveable contact, so that the electrical connection between the external electrical supply and the light emitting diode 32 is re-established. The illumination of the glove compartment is thereby activated.

FIG. 3 shows an alternative development of a damper 10, which instead of a rotational damper comprises an axial damper 44. Such axial dampers 44 are known in the art. Again a light emitting diode 32 is arranged on the damper housing 12 of the damper 10 shown in FIG. 3. Also provided in the example shown in FIG. 3 is a switch 46, in this case a push button 46, formed on the damper housing 12. At one end the damper 10 shown in FIG. 3 comprises a plug device 48, (only represented schematically) for the connection to an electrical supply. The axial damper 44 can be correspondingly connected to the moveable component to be damped. A movement of the component then in turn produces a damped movement inside the axial damper. The switch or push button 46 may also be operated by the movement (or also manually), so that this activates or deactivates the light emitting diode 32 in the desired way.

Although this is not represented in the figures, its is naturally also feasible for the light emitting diode 32 to be replaced by another, preferably electronic component, in particular a movement sensor or the like, which may be coupled to a vehicle alarm system, (for example a temperature sensor, light sensor etc.).

The invention, in a form that is easy to manufacture and assemble, allows a robust supply to a component, especially an electronic component, as a function of the movement of a damped component.

1. Damper for dampening a rotational or linear movement of a component, preferably a component being mounted moveable in the inside of a motor vehicle, with a damper housing characterized in that at least one illumination source and/or at least one sensor as well as an electrical connecting device for the connection of the illumination source or the sensor with an electrical source are integrated into the damper housing housing.

2. Damper according to claim 1, characterized in that the illumination source is a light emitting diode or a light guide or a lighting foil.

3. Damper according to claim 1, characterized in that the sensor is a movement sensor, a temperature sensor or a light sensor.

4. Damper according to claim 1, characterized in that it comprises a plug device being in electrical contact with the electrical connecting device, for connecting with an external electrical supply.

5. Damper according to claim 1, characterized in that it comprises an integrated switch or push button, upon the actuation of which the illumination source and/or the sensor are activated or deactivated.

6. Damper according to claim 5, characterized in that upon actuation of the switch or push button for activating the illumination source and/or the sensor a different electrical device is deactivated, and that upon actuation of the switch or push button for deactivating the illumination source and/or the sensor a different electrical device is activated.

7. Damper according to claim 1, characterized in that in or on the damper housing a gear wheel is provided which is connected torque-proof with a rotor being rotatably mounted in the damper housing and wherein the damper comprises a moveable gear rack engaging with the gear wheel wheel.

8. Damper according to claim 6, characterized in that the switch comprises a switch housing being mounted on the damper housing and two fixed electrical contacts being provided in the switch housing and a third moveable electrical contact also provided in the switch housing, wherein the moveable contact is moveable between a position electrically connecting the fixed contacts and a position electrically separating the fixed contacts, and wherein the moveable contact is moveable upon a relative movement between the gear rack and the switch provided on the damper housing.

9. Damper according to claim 7, characterized in that in the damper housing a damper with a damper fluid is provided, in which the rotor rotates upon a movement of the gear wheel or, that the rotor comprises at least one friction element, which is in frictional contact with a surface of the damper housing upon a rotation of the rotor.

10. Damper according to claim 1, characterized in that at least the damper housing consists of a plastic material.

11. Damper according to claim 10, characterized in that the electrical connecting device comprises a metallic conduction device being integrated into the damper housing, wherein the damper housing is moulded onto the conduction device in an injection molding process.

12. Damper according to claim 1, in a state being mounted on a component to be dampened, wherein the damper is mounted with its damper housing behind a wall, and wherein the wall comprises an opening, on which opening the illumination source and/or the sensor are provided.

13. Damper according to claim 12, characterized in that the component is a cover which either frees or closes an inner space being at least partially delimited by the wall wherein the damper housing is mounted on the side of the wall facing away from the inner space, and wherein the illumination source and/or the sensor is facing towards the inner space through the opening of the wall.

14. Damper according to claim 12, characterized in that the damper housing comprises at least one projection and, that the wall comprises at least one recess, through which the at least one projection of the damper housing can be guided, wherein the at least one projection can be rotated into a position engaging behind the wall by rotating the damper housing, so that the damper housing is fixed on the wall.

15. Damper according to claim 1, characterized in that the illumination source is provided with a diffusor for distributing the light.
